(19) United States
(12) Patent Application Publication
(10) Pub. No.: US 2022/0300834 A1
(43) Pub. Date: Sep. 22, 2022

(54) KNOWLEDGE-BASED VALIDATION OF EXTRACTED ENTITIES WITH CONFIDENCE CALIBRATION

(71) Applicant: IRON MOUNTAIN INCORPORATED, Boston, MA (US)

(72) Inventors: Zhihong Zeng, Acton, MA (US); Andy Jennings, Boston, MA (US); Narasimha Goli, Boston, MA (US); Denise Aker, Boston, MA (US); Anwar Chaudhry, Mississauga (CA)

(73) Assignee: IRON MOUNTAIN INCORPORATED, Boston, MA (US)

(21) Appl. No.: 17/696,603

(22) Filed: Mar. 16, 2022

Related U.S. Application Data
(60) Provisional application No. 63/161,746, filed on Mar. 16, 2021.

(51) Int. Cl. G06N 5/02; G06V 30/19; G06V 30/414

(52) U.S. Cl. CPC G06N 5/022; G06V 30/1916; G06V 30/414; G06F 40/295

(57) ABSTRACT

In some embodiments, techniques for knowledge-based validation of entities extracted from digital documents are provided. For example, a process may involve selecting, from among a plurality of entities extracted from a digital document, a first set of correlated entities. Selecting the first set of correlated entities may be based on a correlation that is indicated by relative location of the entities of the first set of correlated entities within the digital document or by similarity among tags of the entities of the first set. The method may also include determining, using a knowledge model, that the first set of correlated entities is not valid; and generating, using the knowledge model, a first modified set of correlated entities, wherein each entity of the first modified set of correlated entities corresponds to a respective entity of the first set of correlated entities.

### TECHNICAL FIELD

The field of the present disclosure relates to document processing. More specifically, the present disclosure relates to techniques for validating information units extracted from digital documents.

### BACKGROUND

Uncertainty in the predictions generated by a machine learning (ML) model may be represented by confidence values. Model uncertainty may include aleatoric uncertainty (e.g., caused by noise inherent in the observation) or epistemic uncertainty (e.g., caused by training data sparsity). Most existing ML models are implemented with aleatoric uncertainty.

### SUMMARY

Certain embodiments involve knowledge-based validation of entities extracted from digital documents. For example, a method for knowledge-based validation includes selecting, from among a plurality of entities extracted from a digital document, a first set of correlated entities (e.g., by an entity selection module). Selecting the first set of correlated entities is based on a correlation that is indicated by relative location of the entities of the first set of correlated entities within the digital document or by similarity among tags of the entities of the first set. The method also includes determining, using a knowledge model, that the first set of correlated entities is not valid (e.g., by a validation module). The method further includes generating, using the knowledge model, a first modified set of correlated entities (e.g., by the validation module), wherein each entity of the first modified set of correlated entities corresponds to a respective entity of the first set of correlated entities. Systems for knowledge-based validation, and methods and systems for confidence calibration based on such validation, are also disclosed.

These illustrative embodiments are mentioned not to limit or define the disclosure, but to provide examples to aid understanding thereof. Additional embodiments are discussed in the Detailed Description, and further description is provided there.

### BRIEF DESCRIPTION OF THE DRAWINGS

Features, embodiments, and advantages of the present disclosure are better understood when the following Detailed Description is read with reference to the accompanying drawings.

FIG. 1 shows a block diagram of a knowledge-based validation system according to certain aspects of the present disclosure.

FIG. 2A shows a block diagram of a machine learning (ML) process that includes knowledge validation of a prediction, according to certain aspects of the present disclosure.

FIG. 2B shows an example of an architecture or framework for processing a digital document, according to certain aspects of the present disclosure.

FIGS. 3A and 3B show an example of a portion of a digital document before and after de-skewing, respectively.

FIG. 4 shows an example of detecting text regions of interest (ROIs).

FIG. 5 shows an example of optical character recognition (OCR).

FIGS. 6 and 7 show an example of a natural language (NL) entity extraction model.

FIGS. 8A and 9A show examples of knowledge graph/database generation, according to certain aspects of the present disclosure.

FIGS. 8B and 9B show examples of building database indices, according to certain aspects of the present disclosure.

FIG. 10 shows portions of a US person name database, according to certain aspects of the present disclosure.

FIG. 11A shows rules that identify invalid Social Security Numbers (SSNs), and FIG. 11B shows a portion of a table.

FIG. 12 depicts an example of a process of knowledge-based validation, according to certain aspects of the present disclosure.

FIG. 13 shows a flowchart of a process of knowledge validation and search, according to certain aspects of the present disclosure.

FIGS. 14 and 15 show an example of a python code listing, according to certain aspects of the present disclosure.

FIGS. 16, 17, and 18 show example of python code listings, according to certain aspects of the present disclosure.

FIG. 19 shows a block diagram of an example computing device, according to certain aspects of the present disclosure.

### DETAILED DESCRIPTION

The subject matter of embodiments of the present disclosure is described here with specificity to meet statutory requirements, but this description is not necessarily intended to limit the scope of the claims. The claimed subject matter may be implemented in other ways, may include different elements or steps, and may be used in conjunction with other existing or future technologies. This description should not be interpreted as implying any particular order or arrangement among or between various steps or elements except when the order of individual steps or arrangement of elements is explicitly described.

Uncertainty in the predictions generated by a machine learning (ML) model may be represented by confidence values. For example, a confidence value may indicate how reliable a model prediction is. Confidence calibration of a machine learning (ML) model may play an important role for many applications, such as self-driving vehicles, medical diagnosis, and human-in-the-loop systems.

Certain aspects and examples of the disclosure relate to techniques for extracting and validating information units from digital documents. A computing platform may access one or more unstructured documents and perform processing operations on the documents. In some examples, the processing can include text region detection, signature detection, and checkbox detection on the unstructured document. The processing can also include optical character recognition on the detected regions of the unstructured document to generate a structured text of interest representation. Natural language processing may be performed on the structured text of interest representation to extract desired entities from the unstructured document.

Upon processing the unstructured documents to generate the structured text of interest representation, the computing platform may perform natural language processing, such as key-value detection, bag-of-words modeling, deep neural network (DNN) modeling, or question and answer operations, on content of the unstructured document using the structured text of interest representation. For example, the structured text of interest representation of the unstructured document may provide context to the text content within the unstructured document. In this manner, information of interest from the unstructured document may be extracted.

Examples presented herein include architectures or frameworks of document entity extraction with knowledge calibration of model confidence; methods of confidence calculation through pre-processing, OCR, entity extraction and knowledge validation; methods of using knowledge validation logics to boost or downgrade the model confidence; and methods of using knowledge-based fuzzy search to search the noisy/missing entities. Such examples may be applied to a digital document or in general to a corpus of structured or unstructured text. By utilizing the techniques presented herein, the knowledge-based validation can provide information about the model ignorance (epistemic uncertainty) to the out-of-distribution (OOD) dataset which are not covered by the training data.

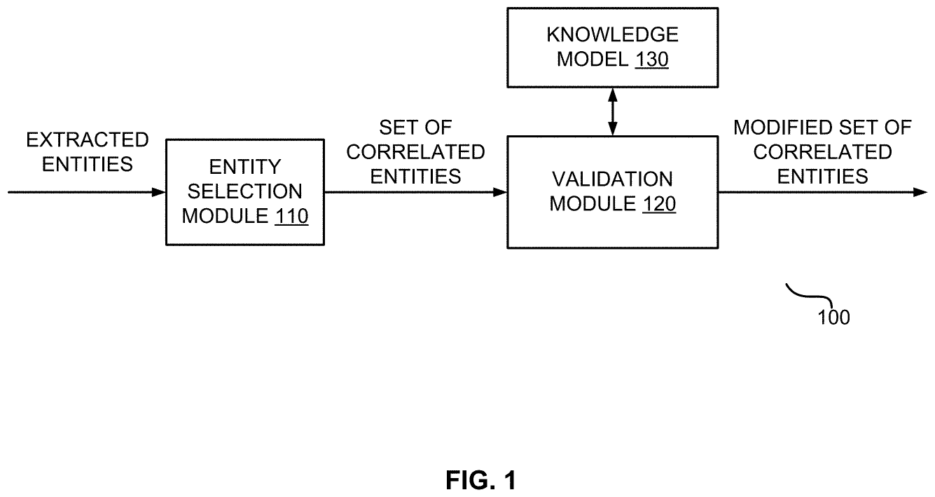

FIG. 1 shows a block diagram of a knowledge-based validation system 100 according to certain aspects of the present disclosure. As shown in FIG. 1, the knowledge-based validation system 100 includes an entity selection module 110 that is configured to select, from among a plurality of entities extracted from a digital document, a set of correlated entities. The knowledge-based validation system 100 also includes a validation module 120 that is configured to determine, using a knowledge model 130, whether the set of correlated entities is valid. The validation module 120 is also configured to generate, using the knowledge model 130, a modified set of correlated entities if the set of correlated entities is not valid, wherein each entity of the modified set of correlated entities corresponds to a respective entity of the set of correlated entities. The validation module 120 may also be configured to calibrate confidence values of the entities of the set of correlated entities as further described herein.

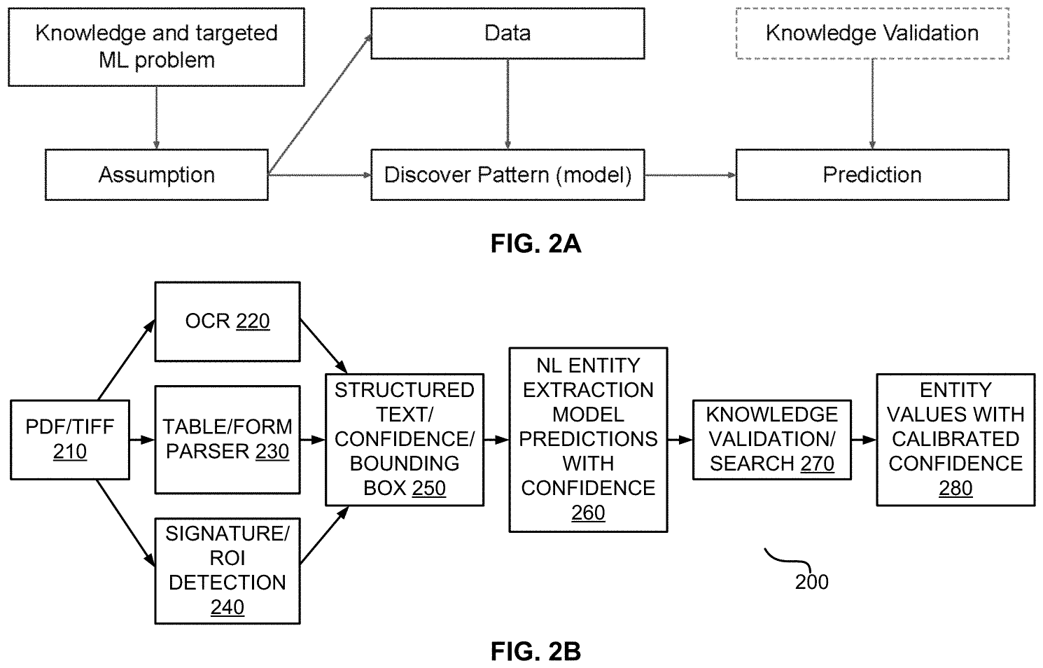

FIG. 2A shows a block diagram of a machine learning (ML) process that includes knowledge validation of a prediction, according to certain aspects of the present disclosure. Such a process may include operations such the following: 1) Start with a knowledge model (e.g., a knowledge database, a knowledge graph) and a targeted ML problem; 2) Propose assumptions to make the solution feasible; 3) Assumptions will guide the data collection and the ML model architecture; 4) Use the data to train and evaluate the ML model; 5) Make a prediction on the new unseen data. Techniques as disclosed herein (e.g., with reference to system 100, process 1200, process 1300, etc.) may be used to extend such a process to further include 6) Use the knowledge model to validate the prediction.

FIG. 2B shows an example of an architecture or framework for processing a digital document 210, which may be in a document format (e.g., Portable Document Format (PDF)) or an image format (e.g., Tagged Image File Format (TIFF)). Extracting text from the digital document may include, for example, optical character recognition (OCR) 220, parsing 230 of tables and/or forms, and/or detecting 240 regions of interest (ROIs), such as signatures. Such extraction may produce structured text 250 with corresponding confidence values that may also include other information such as bounding boxes, which may indicate a correlation among text elements. These results may be processed using a natural language (NL) entity extraction model to generate predictions 260 with confidence. The operations 220, 240, 250, or 260 may be implemented, for example, as described in U.S. patent application Ser. No. 17/694,301 (“DOCUMENT ENTITY EXTRACTION USING DOCUMENT REGION DETECTION”), filed Mar. 14, 2022 by the current applicant. Knowledge validation/search 270 as described herein (e.g., with reference to system 100, process 1200, process 1300, etc.) may be performed on the predictions to obtain entity values 280 with calibrated confidence.

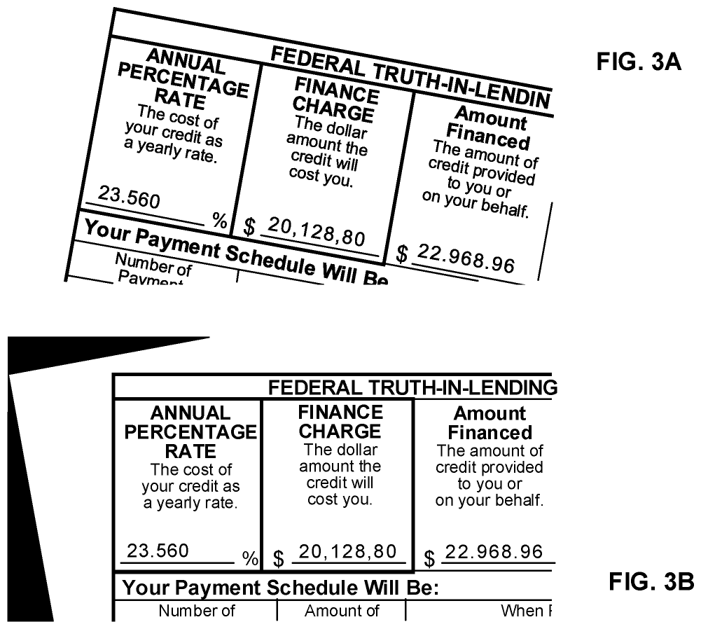

It may be desired to perform one or more pre-processing operations on the digital document before text extraction, such as de-skewing. Pre-processing of the image files may include, for example, any of the following operations: de-noising (e.g., Gaussian smoothing), affine transformation (e.g., de-skewing, translation, rotation, and/or scaling), perspective transformation (e.g., warping), normalization (e.g., mean image subtraction), histogram equalization. Pre-processing may include, for example, scaling the document images to a uniform size. FIGS. 3A and 3B show an example of a portion of a digital document before and after de-skewing, respectively.

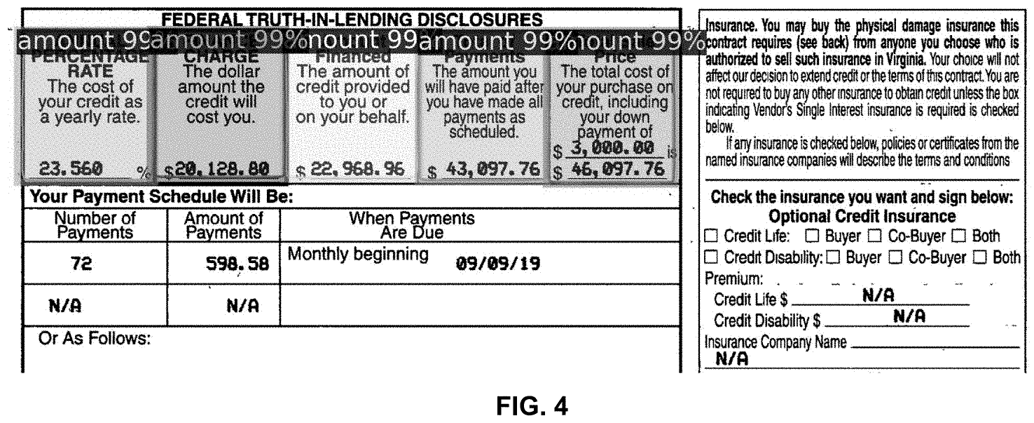

As shown in FIG. 2B, text extraction may include parsing 230 of tables and/or forms, and/or detection 240 of ROIs in the digital document. For example, it may be desired to detect regions of the digital document which contain target entities, such as payment, price, annual percentage rate (APR), etc. FIG. 4 shows an example of detecting text ROIs 240 in which the results contain label class (amount), confidence value (%), and bounding box (illustrated by rectangle color shading).

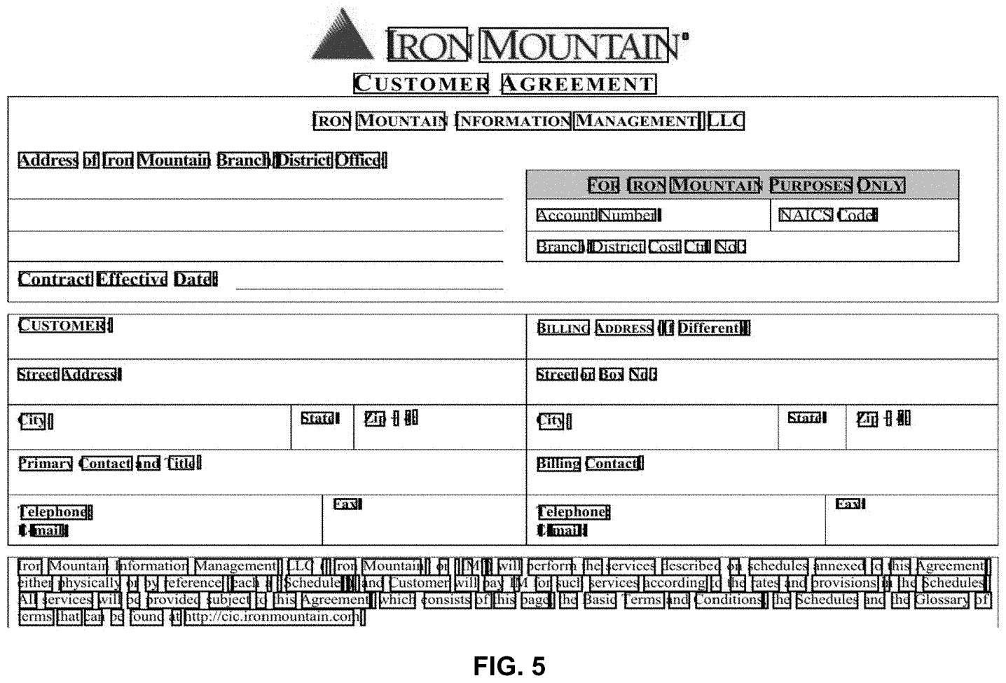

FIG. 5 shows an example of OCR 220, which may be used to extract text (e.g., to generate a text description) by detecting optical characters in the digital document. The OCR operation 220 may also generate text bounding boxes (e.g., as shown for each word in FIG. 5) and/or OCR detection confidence values.

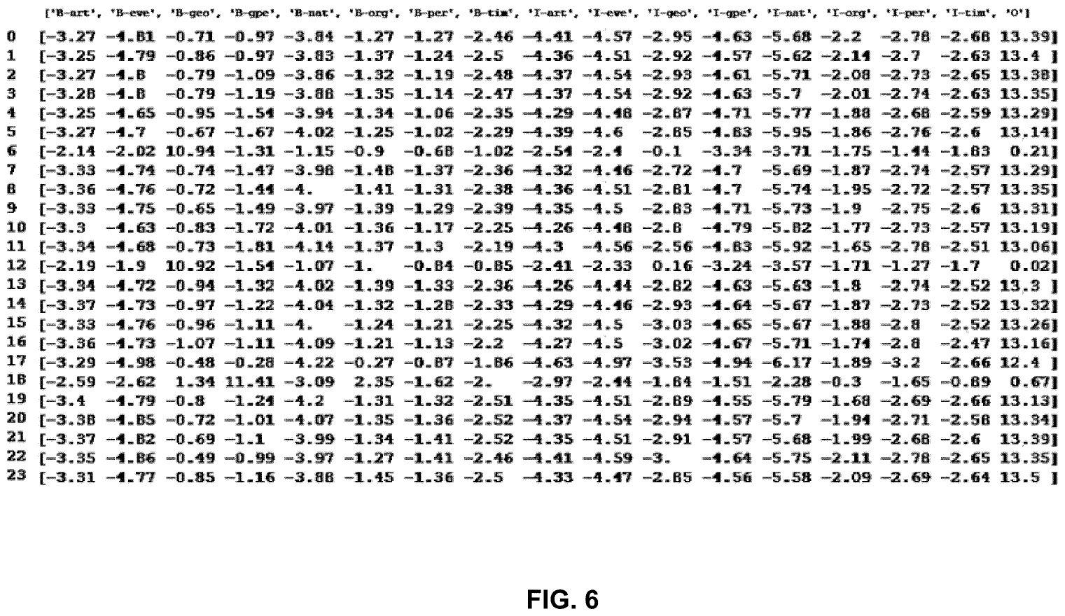

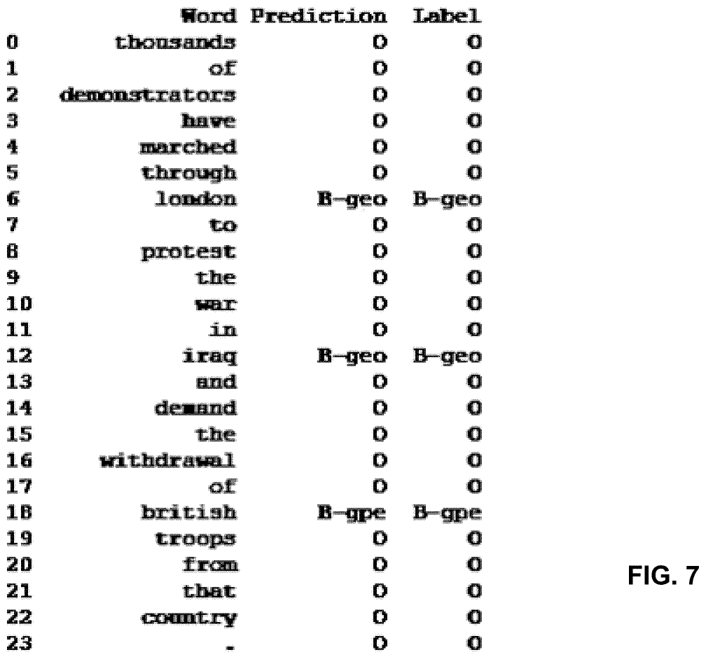

FIGS. 6 and 7 show an example of a natural language (NL) (also called NL understanding (NLU) or NL processing (NLP)) entity extraction model that may be used to process the extracted text to generate predictions 260 with confidence. Such a model may be implemented, for example, as a Deep Bidirectional Transformer Model. The model may be configured to receive a block of text as input (e.g., “Michael visited Iron Mountain in 2012.”) and produce a block of text in which entities are tagged (e.g., “[Michael]Person visited [Iron Mountain]Organization in [2012]Time.”). In the example of FIGS. 6 and 7, the model processes the input block “thousands of demonstrators have marched through london to protest the war in iraq and demand the withdrawal of british troops from that country” to produce predicted tags and corresponding confidence values for the entities.

FIGS. 6 and 7 show an example of inside-outside-beginning (JOB) tagging, in which the prefix I indicates a tag inside a chunk, the prefix B indicates a tag that is a beginning of a chunk, and the tag O indicates that the token belongs to no chunk. In this example, the model uses the following possible tags (in addition to the O tag): geo (geographical entity), org (organization), per (person), gpe (geopolitical entity), tim (time indicator), art (artifact), eve (event), and nat (natural phenomenon). FIG. 6 shows a matrix of prediction values for this example. In FIG. 6, the header row indicates, for each column of the matrix, the corresponding prefix and tag, and the leftmost column indicates, for each row of the matrix, the corresponding word of the input block. FIG. 7 shows the predicted tags for each word of the input block, where the column “Label” indicates ground truth.

The entity selection module 110 may be configured to select a set of correlated entities based on a correlation indicated by relative location of the entities of the first set of correlated entities within the digital document or by similarity among tags of the entities of the first set. Correlation among the extracted entities may be indicated by one or more factors that may include, for example, relative location (e.g., co-location within the same bounding box or ROI) and/or tag similarity (e.g., entities tagged ‘geo’). In one example, the entity selection module 110 may be configured to select entities whose bounding boxes are consecutive to one another in a line or in a column of the digital document, or entities that are extracted from the same table of the digital document (e.g., from adjacent or consecutive boxes of a table), as a set of correlated entities. In another example, the entity selection module 110 may be configured to select entities that occur on the same line of text in a source image, on adjacent lines of text in the source image, and/or within a bounding box or other region of the source image as a set of correlated entities. In a further example (which may be combined with, e.g., one or both of the examples above), the entity selection module 110 may be configured to select entities whose types (e.g., ‘street’, ‘city’, ‘state’, ‘zipcode’) belong to a common class (e.g., ‘address elements’) as a set of correlated entities.

The validation module 120 is configured to validate sets of correlated entities with reference to the knowledge model 130, which may be generated by collecting data and knowledge about the data. The knowledge model 130 may comprise entities and relationships among the entities (e.g., an entity-relationship model). An entity may be, for example, an object, a place, or a person. Each entity may have a type (or “tag”) and a value (or “name”). Examples of types of entities in a knowledge model may include address elements, such as state names, street names, and/or zip codes; business organization data, such as industry, organization name, and/or address elements; personal identifiers, such as first names, middle names, and/or last names; etc. The knowledge model may indicate relationships among, for example, the individual address elements that make up a particular street address; the data elements that pertain to a particular business organization; the first, middle, and last names of a particular person; etc.

The validation module 120 may be configured to determine whether a set of correlated entities is valid by searching the knowledge model 130. For example, the validation module 120 may be configured to search the knowledge model 130, for each entity in the set of correlated entities, to determine whether a matching entity (an entity of the same type and having the same value) is found within the knowledge model 130. The validation module 120 may be configured to further determine whether the matching entities found within the knowledge model 130 are correlated (e.g., connected) in the knowledge model 130. If no such set of correlated matching entities is found in the knowledge model 130, the validation module 120 may determine that the set of correlated entities is not valid.

In one example, the knowledge model 130 is implemented as a knowledge graph, which is made up of nodes and the edges that connect them. Each node is an entity that is connected to at least one other node by a corresponding edge. An edge may define a relationship between the entities it connects. A knowledge graph 130 may be stored in a graph database and visualized as a graph structure.

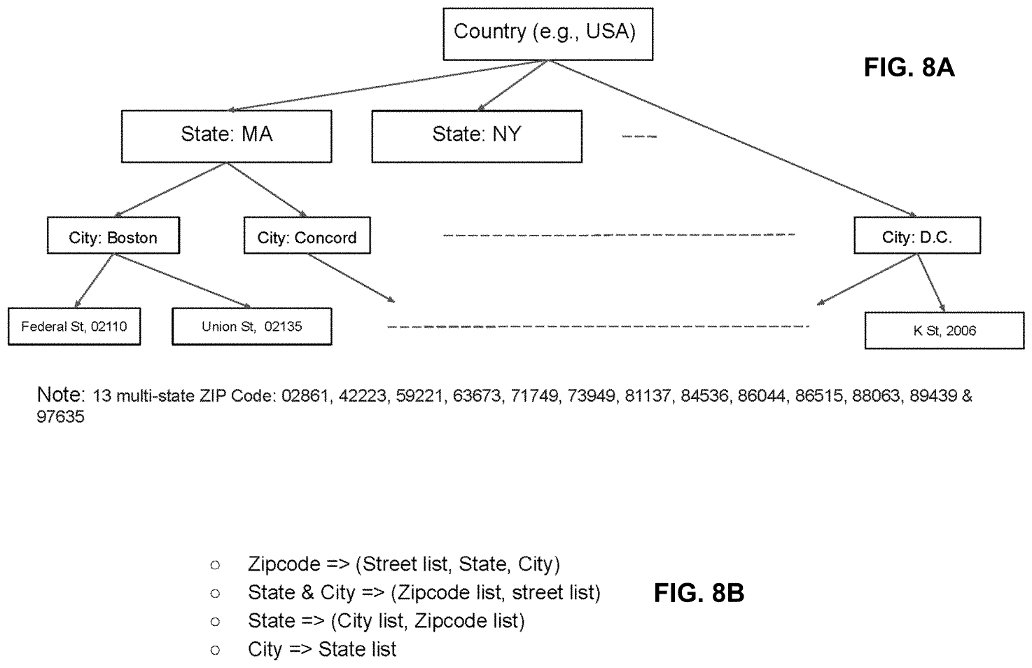

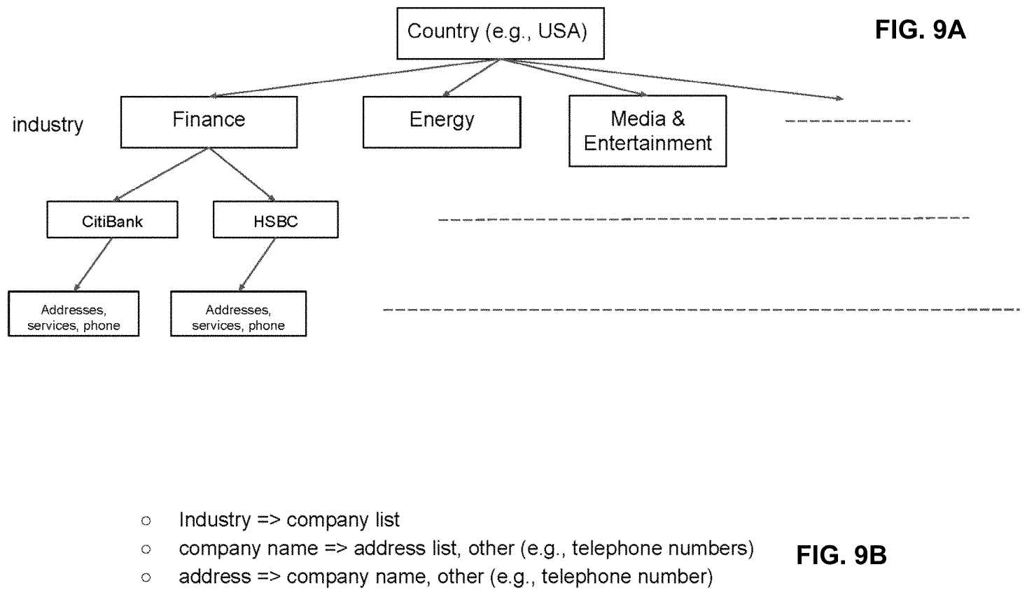

FIG. 8A shows an example of knowledge graph/database generation. This example shows generation of an address knowledge graph 130 using entity tags ‘Street’, ‘City’, ‘State’, and ‘Zipcode’. As shown in this example, a knowledge graph 130 may be implemented such that the nodes of the graph are the tagged entities, and the edges of the graph indicate semantic connections (e.g., correlations) among entities that have different tags. FIG. 9A shows another example of knowledge graph/database generation. This example shows generation of an organization graph or database 130 using entity tags such as Country, Industry, Organization, and others.

It may be desired to normalize entities (e.g., entities in the graph and/or the extracted entities) to a standard form for efficient search in the knowledge graph 130 (e.g., an address graph as shown in FIG. 8A, an organization graph as shown in FIG. 9A). It may be desired, for example, to normalize values of one or more types of entities (e.g., state-name entities, street-name entities, and/or organization-name entities) prior to validation. In one example, state-name entities are normalized to the two-letter abbreviations set forth in Appendix B of United States Postal Service (USPS) Publication 28 “Postal Addressing Standards,” June 2020 (e.g., “MA”, “Mass”, and “Massachusetts” may be normalized to “MA”). In another example, street-name entities are normalized to standards as set forth in Section 2 (“Postal Addressing Standards”), Appendix C1 (“Street Suffix Abbreviations”) or Appendix C2 (“Secondary Unit Designators”) of USPS Publication 28 (e.g., “123 Parker East Street. Apt #10” may be normalized to “Parker E St”).

Normalizing an entity value may include deleting one or more suffixes from the entity value and/or parsing out one or more suffixes (e.g., to another entity) from the entity value. It may be desired, for example, to normalize organization-name entities, and such normalizing may include parsing out (e.g., to another entity) and/or deleting one or more name suffixes, such as a business structure identifier (e.g., “Iron Mountain Inc” may be normalized to “Iron Mountain”).

In another example, the knowledge model 130 is implemented as a database (for example, a relational database). FIGS. 8B and 9B show examples of building database indices that may be used to represent connectedness among entries within a relational database. FIG. 8B shows examples of building database indices among entries (e.g., zipcodes, states, cities, street) within a database of addresses, and FIG. 9B shows examples of building database indices among entries (e.g., industries, organization name, addresses, telephone numbers, services) within a database of business organizations. Such indices may be used, for example, to obtain a knowledge graph from a relational database.

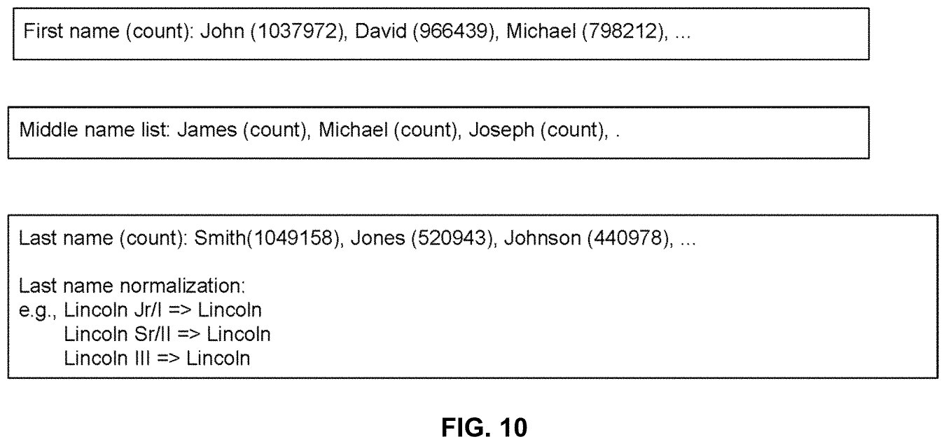

The knowledge graph/database generation may include generating the knowledge model 130 to include a name database. FIG. 10 shows portions of a US person name database. Building such a database may include normalizing last names. As shown in FIG. 10, for example, it may be desired to normalize last-name entities, and such normalizing may include parsing out one or more name suffixes (e.g., to another entity) and/or deleting one or more name suffixes (e.g., generational designation).

In one example, the validation module 120 is configured to validate a first-name entity (e.g., an entity having a label which indicates that the entity is a first name) by determining whether the value of the entity is found within a list of first names, to validate a middle-name entity (e.g., an entity having a label which indicates that the entity is a middle name) by determining whether the value of the entity is found within a list of middle names, and to validate a last-name entity by determining whether the value of the entity is found within a list of last names. In this example, if all three determinations are positive, then the validation module 120 may determine that a set of correlated entities that is formed by the first-name entity, the middle-name entity, and the last-name entity is valid.

The knowledge graph/database generation may include generating a custom knowledge graph/database. For example, an implementation of the knowledge model 130 in an application for the distribution of automobiles may include an entity tag ‘Make’ with possible values such as ‘Ford’, ‘Chevrolet’, Toyota,’ Hyundai’, etc., and an entity tag ‘Model’ with corresponding possible values at a lower level.

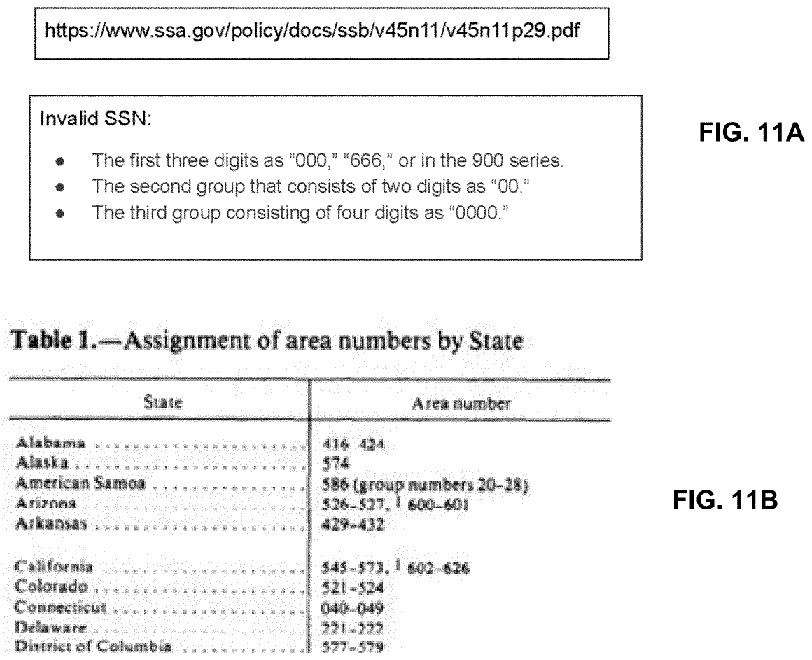

The knowledge graph/database generation may include generating a Social Security Number (SSN) database. As shown in FIG. 11A, this process may include applying rules that identify invalid SSNs. Such a database 130 may be based in part on Table 1 of Social Security Bulletin, November 1982/Vol. 45, No. 11, p. 29 (available online at haps://www.ssa.gov/policy/docs/ssb/v45n11/v45n11p29.pdf (“Meaning of the Social Security Number”)), a portion of which is shown in FIG. 11B.

Each of the extracted entities may have an associated confidence value, which may be a composite of multiple confidence values (e.g., confidence value=(region detection confidence)*(OCR word confidence)*(entity extraction confidence)). If the validation succeeds, then the validation module 120 may calculate the calibrated confidence values for the validated entities by updating the existing confidence values by a factor boost_weight_0. In such a case, the resulting calibrated confidence value for an entity may be (region detection confidence)*(OCR word confidence)*(entity extraction confidence)*(boost_weight_0). In general, the resulting calibrated confidence value for an entity may be (region detection confidence)*(OCR word confidence)*(entity extraction confidence)*(knowledge validation weight), where the knowledge validation weight may be boost_weight_0 or another value as described below.

If the set of correlated entities is not valid, the validation module 120 may use the knowledge model 130 to generate a modified set of correlated entities, where each entity of the modified set of correlated entities corresponds to a respective entity of the set of correlated entities. In one such example, the validation module 120 is configured to generate the modified set of correlated entities by performing an operation of fuzzy string matching (or “approximate string matching”) as described below. In another such example, the validation module 120 is configured to generate the modified set of correlated entities by using a confusion dictionary (e.g., to generate a list of expanded entity candidates).

If validation of the set of correlated entities fails, the validation module 120 may perform an operation of fuzzy string matching (or “approximate string matching”) on the set to find text blocks that match the pattern approximately rather than exactly. Such an operation may be used to identify the correct entities even if the results of OCR are incorrect. Such an operation may be based on the number of transformations needed to transform a source text block into the target one (also called “edit distance threshold (or tolerance)”), where a transformation is a deletion, insertion, or substitution of a character. The edit distance is also called Levenshtein distance. If the fuzzy string matching succeeds (e.g., produces a valid set of entities), then the incorrect entities may be replaced by the corrected ones. In this case, the validation module 120 may calculate the calibrated confidence values for the entities of the set by updating the existing confidence values by a factor boost_weight_1 that is less than boost_weight_0.

In one example of a fuzzy string matching, for each entity xi from the set of correlated entities (e.g., until the fuzzy string matching succeeds), the validation module 120 searches the knowledge model 130 for a matching entity. If a matching entity is found within the knowledge model 130, then the validation module 120 obtains a set of correlated candidates (e.g., entities that are connected to the matching entity) from the knowledge model 130. For each candidate in the set of correlated candidates, the validation module 120 determines whether the set of correlated entities includes an entity for which the edit distance between the candidate and the entity does not exceed a threshold. If this determination is positive for each candidate in the set of correlated candidates, then the fuzzy string matching has succeeded, and the validation module 120 provides the entity xi and the set of correlated candidates as the modified set of correlated entities. For example, the validation module 120 may use the value of each entity in the set of correlated candidates to replace the value of a corresponding entity in the set of correlated entities.

A fuzzy string matching as described above may be explained with the following example, in which the first set of correlated entities is {‘Arnherst’, ‘01002’, ‘MA’} and the edit distance threshold is two. In this example, no matching entity is found in the knowledge model 130 for ‘Amherst’, but a matching entity is found for ‘01002’, and the corresponding set of correlated candidates is {‘Amherst’, ‘MA’}. Because the first set of correlated entities includes, for each of the candidates, an entity for which the edit distance between the candidate and the entity does not exceed the threshold, the fuzzy string matching succeeds, and the value ‘Amherst’ in the first set is replaced with the value ‘Amherst’.

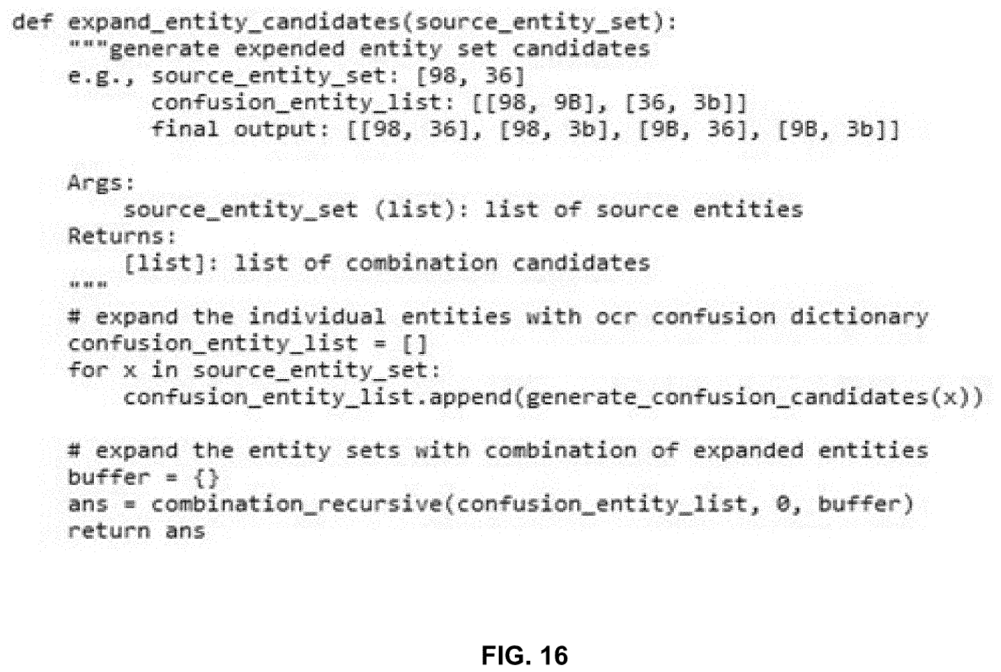

If validation of the set of correlated entities fails, in addition to or in the alternative to an operation of fuzzy string matching (e.g., as described above), the validation module 120 may generate the modified set of correlated entities by using a confusion dictionary (e.g., a dictionary of characters that have been determined to be frequently confused by OCR) to generate an expanded list of entity candidates. One example of such an generation is described in the code listings at FIGS. 16-18. If the use of the confusion dictionary succeeds (e.g., produces a valid modified set of correlated entities), the validation module 120 may calculate the calibrated confidence values for the entities of the set of correlated entities by updating the existing confidence values by a factor boost_weight_2 that is less than boost_weight_1. If the use of the confusion dictionary fails, the validation module 120 may calculate the calibrated confidence values for the entities of the set of correlated entities by updating the existing confidence values by a factor downgrade_weight that is less than boost_weight_2.

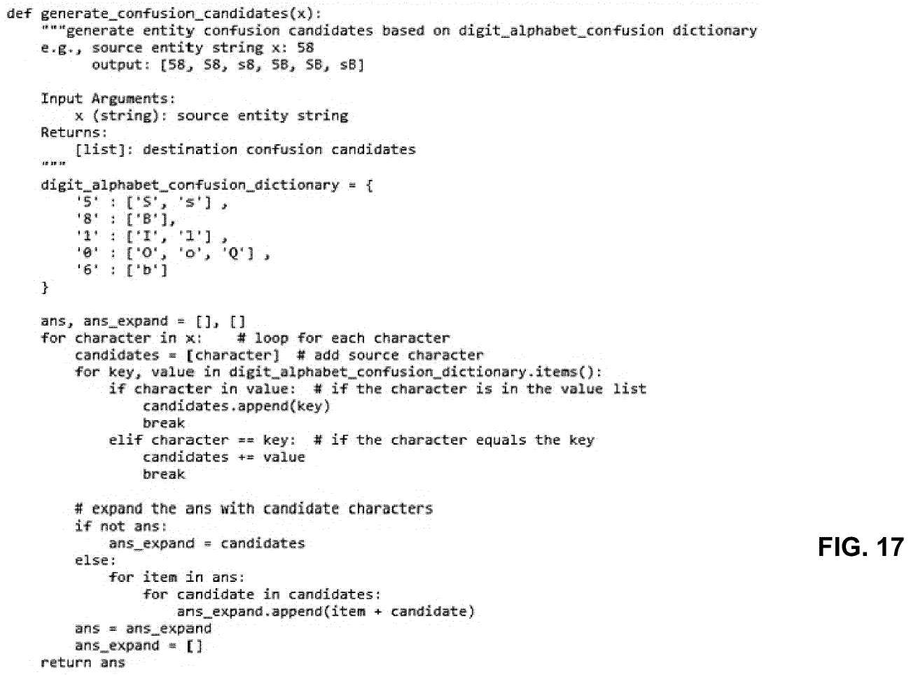

The validation module 120 may be configured to use the confusion dictionary to generate, for each entity among the first set of correlated entities, a corresponding set of entity confusion candidates. For example, the validation module 120 may be configured to generate each candidate in a set of entity confusion candidates by substituting a corresponding value from the confusion dictionary for each of zero or more characters of the corresponding entity. FIG. 17 describes a confusion dictionary that links the key ‘5’ to the values [‘S’, ‘s’], the key ‘8’ to the value [‘B’], the key ‘1’ to the values [‘I’, ‘1’], the key ‘0’ to the values [‘O’, ‘o’, ‘Q’], and the key ‘6’ to the value [‘b’]. In one example, the entity (e.g., as generated by an OCR operation) is ‘Bo5ton’, and the validation module 120 uses the confusion dictionary of FIG. 17 to generate a set of entity confusion candidates that includes the candidates [‘Bo5ton’, ‘Bo5t0n’, ‘B0Ston’, ‘B0StOn’, ‘Boston’, ‘Bost0n’, ‘B05ton’, ‘B05t0n’, ‘B0Ston’, ‘B0St0n’, ‘B0ston’, ‘B0stOn’, ‘8o5ton’, ‘8o5t0n’, ‘8oSton’, . . . ‘80st0n’].

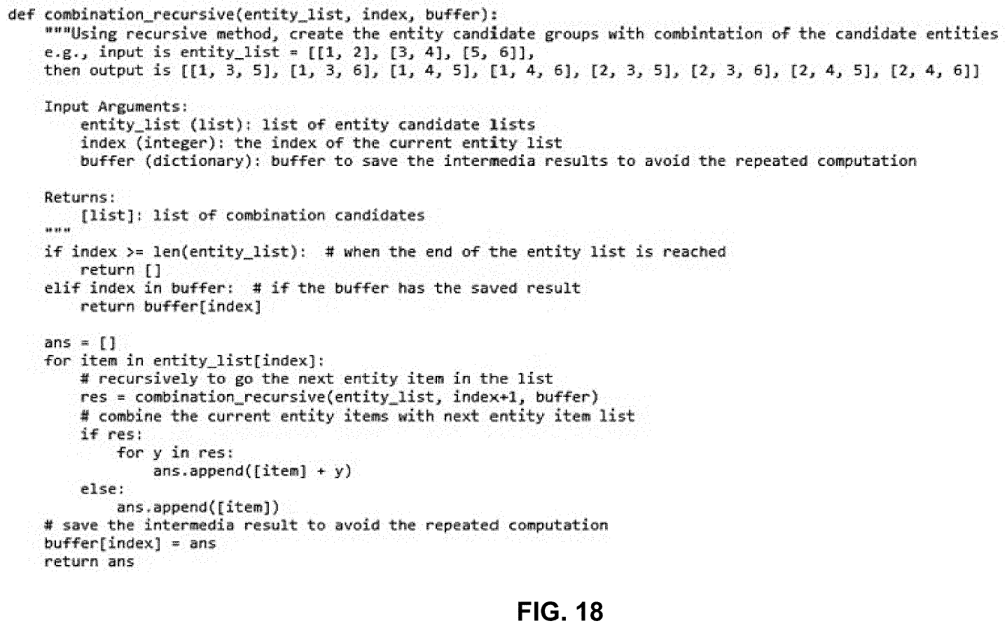

The validation module 120 may also be configured to use the sets of entity confusion candidates to generate a plurality of entity set candidates, wherein each entity set candidate among the plurality of entity set candidates includes an entity from each set of entity confusion candidates. For example, the validation module 120 may be configured to generate each entity set candidate as a combination of one entity selected from each of the set of entity confusion candidates. The validation module 120 may be configured to perform such generation of combinations recursively, as described, for example, in the code listing of FIG. 18.

The validation module 120 may be configured to search the knowledge model 130 for each of the entity set candidates until one of the entity set candidates is validated (e.g., is found in the knowledge model 130), in which case the validated entity set candidate may be returned as the modified set of correlated entities. It will be understood that, before the operation of generating the entity set candidates has completed, the validation module 120 may begin to search the knowledge model 130 for entity set candidates that have already been generated, and that the operation of generating the entity set candidates may be terminated once an entity set candidate has been validated. If none of the entity set candidates is validated, the validation module 120 may calculate the calibrated confidence values for the entities of the set of correlated entities by updating the existing confidence values by a factor downgrade_weight that is less than boost_weight_2 as mentioned above.

In an example, the processes of the knowledge-based validation system 100 may all be performed as microservices of a remote or cloud computing system, or may be implemented in one or more containerized applications on a distributed system (e.g., using a container orchestrator, such as Kubernetes). Alternatively, the processes of the knowledge-based validation system 100 may be performed locally as modules running on a computing platform associated with the knowledge-based validation system 100. In either case, such a system or platform may include multiple processing devices (e.g., multiple computing devices) that collectively perform the process. In some examples, the knowledge-based validation system 100 may be accessed through a detection application programming interface (API). The detection API may be deployed as a gateway to a microservice or a Kubernetes system on which the processes of the knowledge-based validation system 100 may be performed. The microservice or Kubernetes system may provide computing power to serve large scale document processing operations.

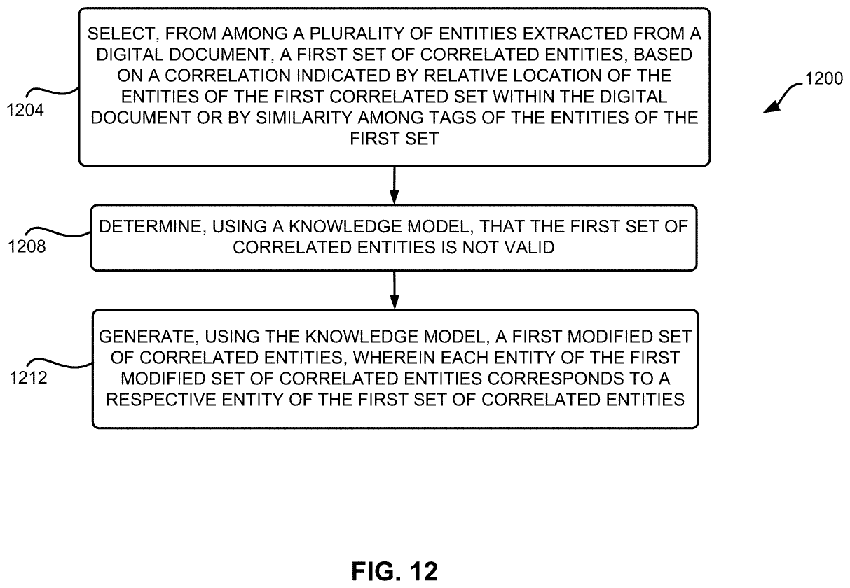

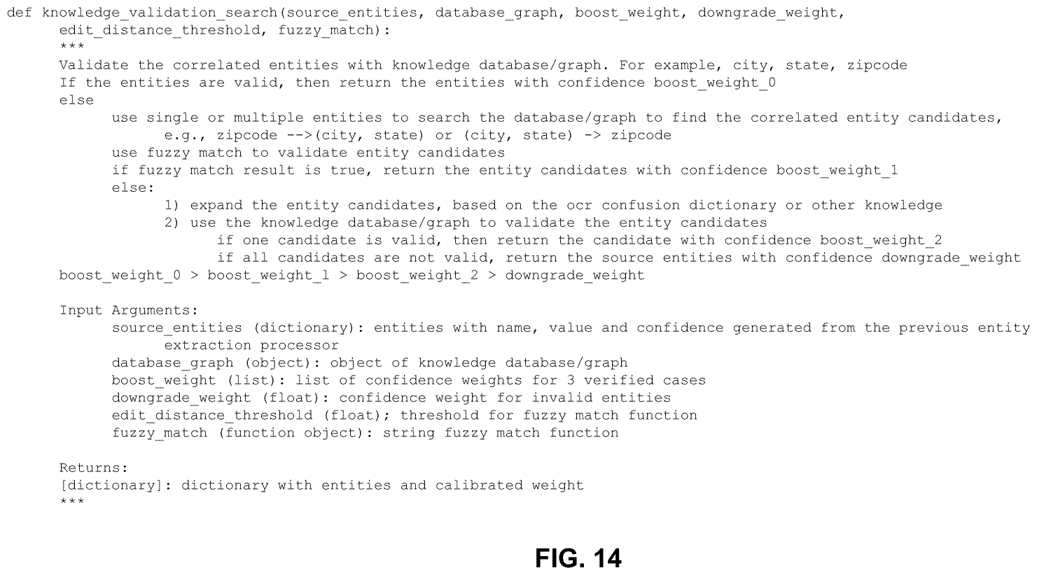

FIG. 12 depicts an example of a process 1200 of knowledge-based validation, according to certain embodiments of the present disclosure. One or more processing devices (e.g., one or more computing devices) implement operations depicted in FIG. 12 by executing suitable program code. For example, process 1200 may be executed by an instance of the knowledge-based validation system 100 (e.g., according to the code listings in FIGS. 14-18). For illustrative purposes, the process 1200 is described with reference to certain examples depicted in the figures. Other implementations, however, are possible.

At block 1204, the knowledge-based validation process involves selecting (e.g., by an entity selection module as described herein), from among a plurality of entities extracted from a digital document, a first correlated set of entities, based on a correlation indicated by relative location of the entities of the first correlated set within the digital document or by similarity among tags of the entities of the first set.

At block 1208, the knowledge-based validation process involves determining (e.g., by a validation module as described herein), using a knowledge model, that the first correlated set of entities is not valid. Determining that the first set of correlated entities is not valid may include determining that the first set of correlated entities is not present in the knowledge model. Determining that the first set of correlated entities is not valid may include determining that at least one entity of the first set of correlated entities is not present in the knowledge model. Determining that the first set of correlated entities is not valid may include determining that the knowledge model lacks a set of correlated entities that corresponds to the first set of correlated entities.

At block 1212, the knowledge-based validation process involves generating (e.g., by the validation module as described herein), using the knowledge model, a first modified correlated set of entities, wherein each entity of the first modified correlated set of entities corresponds to a respective entity of the first correlated set. For each entity of the first modified correlated set of entities, a confidence value of the entity may be based on a confidence value of the corresponding respective entity of the first correlated set and on a first validation weight.

Generating the first modified set of correlated entities may include, based on a first entity of the first set of correlated entities, obtaining a set of correlated candidates from the knowledge model; and determining that, for each candidate among the set of correlated candidates, the first correlated set includes an entity for which an edit distance between the candidate and the entity does not exceed a threshold. The set of correlated candidates may be correlated in the knowledge model with the first entity of the first set of correlated entities.

Alternatively, generating the first modified set of correlated entities may include, for each entity among the first set of correlated entities, generating, using a confusion dictionary, a corresponding set of entity confusion candidates, and generating a plurality of entity set candidates, wherein each entity set candidate among the plurality of entity set candidates includes an entity from each set of entity confusion candidates, and wherein the first modified set of correlated entities is one of the plurality of entity set candidates.

The knowledge-based validation process 1200 may also involve selecting, from among a plurality of entities extracted from a second digital document, a second set of correlated entities, based on a correlation indicated by relative location of the entities of the second set within the second digital document or by similarity among tags of the entities of the second set; determining, using the knowledge model, that the second set of correlated entities is not valid; and generating, using the knowledge model, a second modified set of correlated entities, wherein each entity of the second modified set of correlated entities corresponds to a respective entity of the second set of correlated entities. In such case, the process may also involve, for each entity of the second modified set of correlated entities, using a second validation weight that is less than the first validation weight to weight a confidence value of the entity.

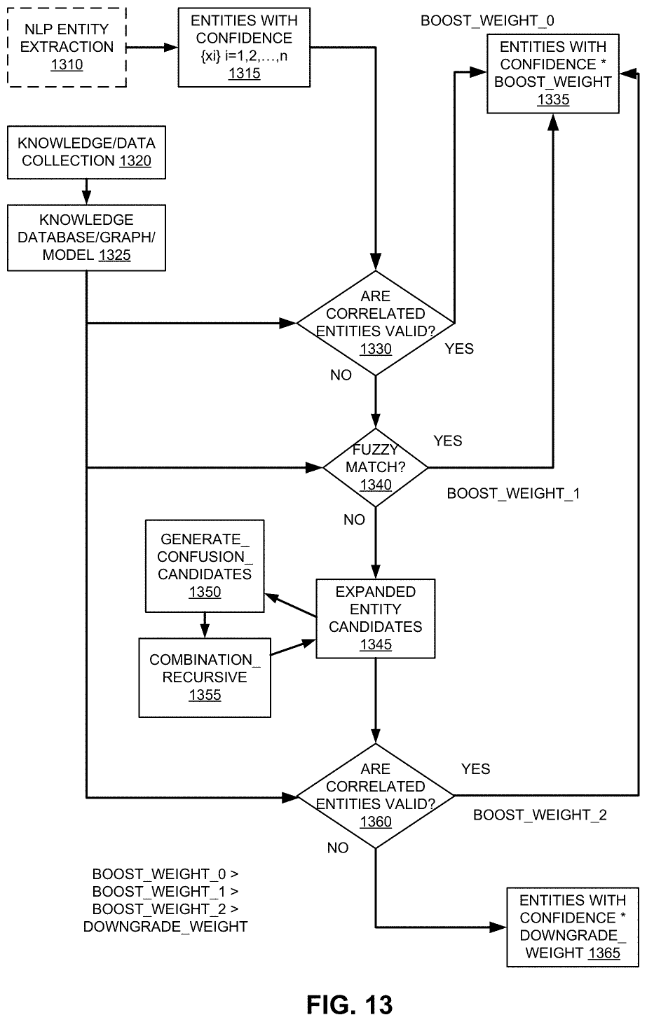

FIG. 13 shows a flowchart of a process of knowledge validation and search that may be performed on the predictions (e.g., extracted entities, or tagged entities with associated confidence values) to obtain an entity value with calibrated confidence. Prior to the process, knowledge and data may be collected (block 1320) and used to construct a knowledge database/graph/model (block 1325), such as knowledge model 130 as described herein, and NLP entity extraction may be performed, e.g. on digital documents (block 1310), to provide extracted entities {xi}, i=1, 2, . . . , n, with corresponding confidence values (block 1315).

At block 1330, the process involves determining whether the correlated entities of a set selected from among the extracted entities are valid (e.g., as described herein with reference to block 1208). If yes, then the entities are calibrated with confidence*boost_weight_0 (block 1335). If no, at block 1340, the process involves performing a fuzzy string matching (e.g., as described herein with reference to the validation module 120). If the set of entities resulting from the fuzzy string matching is valid, then the entities are calibrated with confidence*boost_weight_1 (block 1335). Otherwise, at block 1345 the process involves performing an expand_entity_candidates operation, which calls operations of generate_confusion_candidates (block 1350) and combination_recursive (block 1355). If the set of entities resulting from the expanded entity candidates operation is valid (block 1360), then the entities are calibrated with confidence*boost_weight_1 (block 1335). Otherwise, the set of correlated entities are calibrated with confidence*downgrade_weight (block 1365).

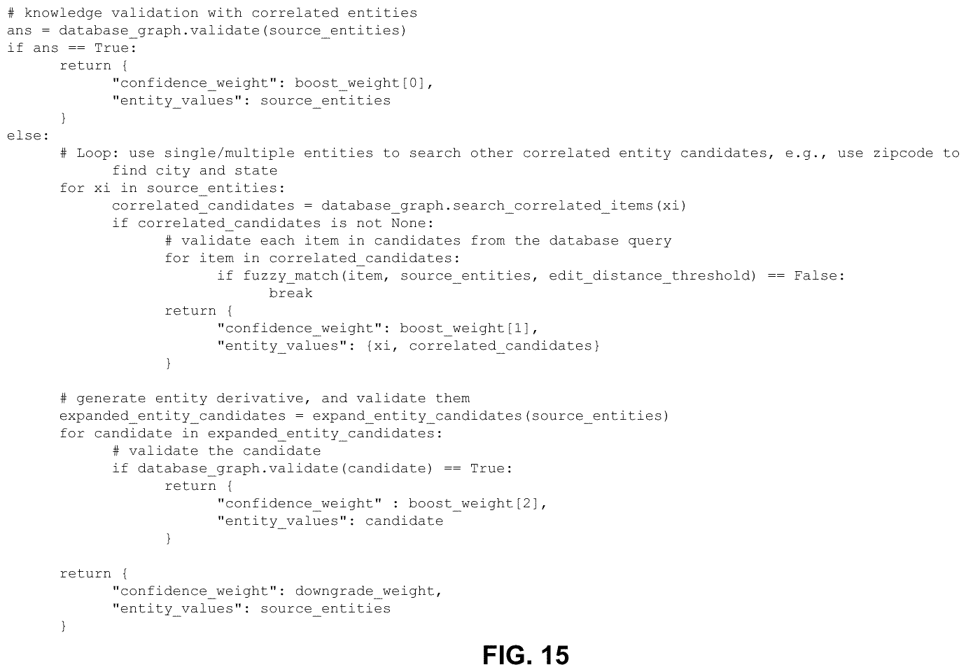

FIGS. 14 and 15 show an example of a python code listing (beginning on FIG. 14 and continuing to FIG. 15) that describes an implementation of blocks 1330-1365 of the knowledge-based validation and search as shown in FIG. 13.

FIG. 16 shows an example of a python code listing that describes an implementation of the expand_entity_candidates operation as shown at block 1345 in FIG. 13. If the entity expansion produces a valid set of entities, then the set of entities may be modified to correspond to the validated set, and the calibrated confidence values for the entities of the validated set may be calculated by updating the existing confidence values by a factor boost_weight_2 that is less than boost_weight_1.

FIG. 17 shows an example of a python code listing that describes an implementation of the generate_confusion_candidates operation as shown at block 1350 in FIG. 13. Such an operation may generate entity confusion candidates based on a confusion dictionary, such as a dictionary of characters that have been determined to be frequently confused by OCR (e.g., the digit_alphabet_confusion dictionary as described in FIG. 17).

FIG. 18 shows an example of a python code listing that describes an implementation of the combination_recursive operation as shown at block 1355 in FIG. 13. Such an operation may be implemented to use a recursive method to create the entity candidate groups as combinations of the candidate entities.

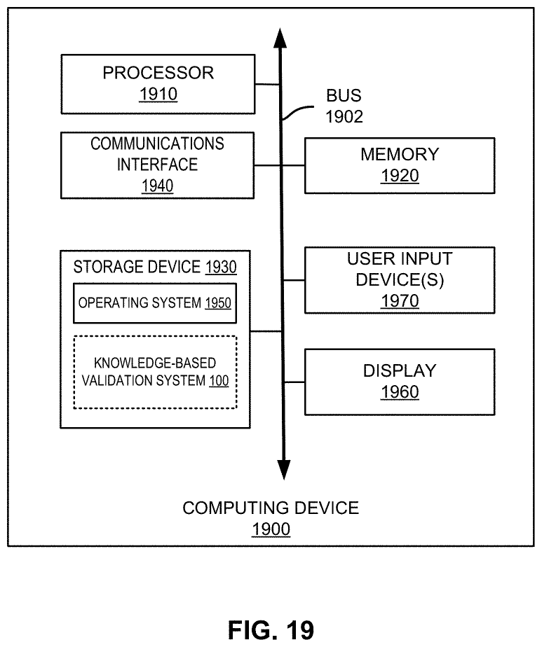

FIG. 19 shows an example computing device 1900 suitable for implementing aspects of the techniques and technologies presented herein. The example computing device 1900 includes a processor 1910 which is in communication with a memory 1920 and other components of the computing device 1900 using one or more communications buses 1902. The processor 1910 is configured to execute processor-executable instructions stored in the memory 1920 to perform secure data protection and recovery according to different examples, such as part or all of the example processes shown in FIG. 12 or 13 or other processes described above with respect to FIGS. 1-18. In an example, the memory 1920 is a non-transitory computer-readable medium that is capable of storing the processor-executable instructions. The computing device 1900, in this example, also includes one or more user input devices 1970, such as a keyboard, mouse, touchscreen, microphone, etc., to accept user input. The computing device 1900 also includes a display 1960 to provide visual output to a user. In other examples of a computing device (e.g., a device within a cloud computing system), such user interface devices may be absent.

The computing device 1900 can also include or be connected to one or more storage devices 1930 that provides non-volatile storage for the computing device 1900. The storage devices 1930 can store an operating system 1950 utilized to control the operation of the computing device 1900. The storage devices 1930 can also store other system or application programs and data utilized by the computing device 1900, such as modules implementing the functionalities provided by a knowledge-based validation system as described herein or any other functionalities described above with respect to FIGS. 1-18. The storage devices 1930 might also store other programs and data not specifically identified herein.

The computing device 1900 can include a communications interface 1940. In some examples, the communications interface 1940 may enable communications using one or more networks, including: a local area network (“LAN”); wide area network (“WAN”), such as the Internet; metropolitan area network (“MAN”); point-to-point or peer-to-peer connection; etc. Communication with other devices may be accomplished using any suitable networking protocol. For example, one suitable networking protocol may include Internet Protocol (“IP”), Transmission Control Protocol (“TCP”), User Datagram Protocol (“UDP”), or combinations thereof, such as TCP/IP or UDP/IP.

While some examples of methods and systems herein are described in terms of software executing on various machines, the methods and systems may also be implemented as specifically configured hardware, such as field-programmable gate arrays (FPGAs) specifically, to execute the various methods. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media (for example, computer-readable storage media) that may store instructions that, when executed by the processor, can cause the processor to perform the steps described herein as carried out, or assisted, by a processor. Examples of computer-readable media may include, but are not limited to, an electronic, optical, magnetic, or other storage device capable of providing a processor, such as the processor in a web server, with computer-readable instructions. Other examples of media comprise, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code for carrying out one or more of the methods (or parts of methods) described herein.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C. For the purposes of the present document, the phrase “A is based on B” means “A is based on at least B”.

Different arrangements of the components depicted in the drawings or described above, as well as components and steps not shown or described are possible. Similarly, some features and sub-combinations are useful and may be employed without reference to other features and sub-combinations. Embodiments of the presently subject matter have been described for illustrative and not restrictive purposes, and alternative embodiments will become apparent to readers of this patent. Accordingly, the present disclosure is not limited to the embodiments described above or depicted in the drawings, and various embodiments and modifications may be made without departing from the scope of the claims below.

1. A computer-implemented method, the method comprising:
selecting, from among a plurality of entities extracted from a digital document, a first set of correlated entities, based on a correlation indicated by relative location of the entities of the first set within the digital document or by similarity among tags of the entities of the first set;
determining, using a knowledge model, that the first set of correlated entities is not valid; and
generating, using the knowledge model, a first modified set of correlated entities, wherein each entity of the first modified set of correlated entities corresponds to a respective entity of the first set of correlated entities.

2. The computer-implemented method according to claim 1, wherein, for each entity of the first modified set of correlated entities, a confidence value of the entity is based on a confidence value of the corresponding respective entity of the first set of correlated entities and on a first validation weight.

3. The computer-implemented method according to claim 1, wherein determining that the first set of correlated entities is not valid includes determining that the first set of correlated entities is not present in the knowledge model.

4. The computer-implemented method according to claim 1, wherein determining that the first set of correlated entities is not valid includes determining that at least one entity of the first set of correlated entities is not present in the knowledge model.

5. The computer-implemented method according to claim 1, wherein determining that the first set of correlated entities is not valid includes determining that the knowledge model lacks a set of correlated entities that corresponds to the first set of correlated entities.

6. The computer-implemented method according to claim 1, wherein generating the first modified set of correlated entities includes:
based on a first entity of the first set of correlated entities, obtaining a set of correlated candidates from the knowledge model; and
determining that, for each candidate among the set of correlated candidates, the first correlated set includes an entity for which an edit distance between the candidate and the entity does not exceed a threshold.

7. The computer-implemented method according to claim 6, wherein the set of correlated candidates is correlated in the knowledge model with the first entity of the first set of correlated entities.

8. The computer-implemented method according to claim 6, wherein, for each entity of the first modified set of correlated entities, a confidence value of the entity is based on a confidence value of the corresponding respective entity of the first set of correlated entities and on a first validation weight, and
wherein the method further comprises:
selecting, from among a plurality of entities extracted from a second digital document, a second set of correlated entities, based on a correlation indicated by at least one among relative location of the entities of the second set within the second digital document and similarity among tags of the entities of the second set; and
for each entity of the second set of correlated entities, and based on determining, using the knowledge model, that the second set of correlated entities is valid, using a second validation weight that is greater than the first validation weight to weight a confidence value of the entity.

9. The computer-implemented method according to claim 6, wherein, for each entity of the first modified set of correlated entities, a confidence value of the entity is based on a confidence value of the corresponding respective entity of the first set of correlated entities and on a first validation weight, and
wherein the method further comprises:
selecting, from among a plurality of entities extracted from a second digital document, a second set of correlated entities, based on a correlation indicated by relative location of the entities of the second set within the second digital document or by similarity among tags of the entities of the second set;
determining, using the knowledge model, that the second set of correlated entities is not valid; and
generating, using the knowledge model, a second modified set of correlated entities, wherein each entity of the second modified set of correlated entities corresponds to a respective entity of the second set of correlated entities; and
for each entity of the second modified set of correlated entities, using a third validation weight that is less than the first validation weight to weight a confidence value of the entity,
wherein generating the second modified set of correlated entities includes:
for each entity among the second set of correlated entities, generating, using a confusion dictionary, a corresponding set of entity confusion candidates; and
generating a plurality of entity set candidates, wherein each entity set candidate among the plurality of entity set candidates includes an entity from each set of entity confusion candidates, and wherein the second modified set of correlated entities is one of the plurality of entity set candidates.

10. The computer-implemented method according to claim 1, wherein generating the first modified set of correlated entities includes:
for each entity among the first set of correlated entities, generating, using a confusion dictionary, a corresponding set of entity confusion candidates, and
generating a plurality of entity set candidates, wherein each entity set candidate among the plurality of entity set candidates includes an entity from each set of entity confusion candidates, and wherein the first modified set of correlated entities is one of the plurality of entity set candidates.

11. A knowledge-based validation system, the system comprising:
one or more processing devices; and
one or more non-transitory computer-readable media communicatively coupled to the one or more processing devices, wherein the one or more processing devices are configured to execute the program code stored in the non-transitory computer-readable media and thereby perform operations comprising:
selecting, from among a plurality of entities extracted from a digital document, a first set of correlated entities, based on a correlation indicated by relative location of the entities of the first set within the digital document or by similarity among tags of the entities of the first set;
determining, using a knowledge model, that the first set of correlated entities is not valid; and
generating, using the knowledge model, a first modified set of correlated entities, wherein each entity of the first modified set of correlated entities corresponds to a respective entity of the first set of correlated entities.

12. The system according to claim 11, wherein, for each entity of the first modified set of correlated entities, a confidence value of the entity is based on a confidence value of the corresponding respective entity of the first set of correlated entities and on a first validation weight.

13. The system according to claim 11, wherein determining that the first set of correlated entities is not valid includes determining that the first set of correlated entities is not present in the knowledge model.

14. The system according to claim 11, wherein determining that the first set of correlated entities is not valid includes determining that at least one entity of the first set of correlated entities is not present in the knowledge model.

15. The system according to claim 11, wherein generating the first modified set of correlated entities includes:
for each entity among the first set of correlated entities, generating, using a confusion dictionary, a corresponding set of entity confusion candidates, and
generating a plurality of entity set candidates, wherein each entity set candidate among the plurality of entity set candidates includes an entity from each set of entity confusion candidates, and wherein the first modified set of correlated entities is one of the plurality of entity set candidates.

16. The system according to claim 11, wherein generating the first modified set of correlated entities includes:
based on a first entity of the first set of correlated entities, obtaining a set of correlated candidates from the knowledge model; and
determining that, for each candidate among the set of correlated candidates, the first correlated set includes an entity for which an edit distance between the candidate and the entity does not exceed a threshold.

17. The system according to claim 16, wherein the set of correlated candidates is correlated in the knowledge model with the first entity of the first set of correlated entities.

18. The system according to claim 11, wherein the knowledge model comprises a knowledge graph.

19. The system according to claim 11, wherein the knowledge model comprises a database.

20. A non-transitory computer-readable medium comprising computer-executable instructions to cause a computer to perform the computer-implemented method of claim 1.
